(19) United States
(12) Patent Application Publication
(10) Pub. No.: US 2002/0081027 A1
(43) Pub. Date: Jun. 27, 2002

(54) Method for electronic transport of digital ink

(75) Inventors: Manjirnath Chatterjee, Sunnyvale, CA (US); Gregory R. Simon, Los Altos, CA (US)

Correspondence Address: MOTOROLA, INC., 1303 EAST ALGONQUIN ROAD, IL01/3RD, SCHAUMBURG, IL, 60196

(73) Assignee: MOTOROLA, INC.

(21) Appl. No.: 09/747,079

(22) Filed: Dec. 21, 2000

(51) Int. Cl. G06K 9/34

(52) U.S. Cl. 382/173

(57) ABSTRACT

A method and computer program product for transporting digital images across electronic media. A digital image 122, e.g., a signature, a handwritten note, a paint program file or anime, captured in a digital ink file 124 is converted or compressed 126 into a string 128 of binary bits. The bit string 128 is mapped 130 into displayable characters such as ASCII characters. The displayable characters are embedded 132 into a message, such as being included in the text of an e-mail message and the message is transmitted electronically. When the message is received 142, the embedded displayable characters are stripped 144 from it. The displayable characters are mapped 146 to their binary equivalents and the mapped binary data stream 148 is reconverted or decompressed 150 to recover the digital ink file 124. The original digital ink image 153 is displayed from the digital ink file 124.

### DESCRIPTION

### RELATED APPLICATION

The present application is related to U.S. patent application Ser. No. 09/______ (Attorney Docket No. LX00088) entitled “COMPRESSION OF DIGITAL INK” to Manjirnath Chatterjee, filed coincident herewith and assigned to the assignee of the present invention.

### BACKGROUND OF THE INVENTION

1. Field of the Invention

The present invention relates generally to transporting non-textual images electronically and, more particularly, to transporting graphical images across electronic medium.

2. Background Description

The term digital ink has many meanings within the art. As used herein, digital ink refers to a digital representation of a non-textual image or manually generated image, such as a signature, a handwritten note or a graphical image. As the use of electronic signatures increases in e-commerce, sending and maintaining the integrity of signatures encoded in digital ink is rising in importance.

Currently, there are several ways to represent digital ink for transmission across electronic mediums. However, normal electronic transmission methods, e.g., e-mail, may filter out the digital ink from the message, especially when using certain e-mail service protocols. The digital ink may be corrupted by the e-mail service when it is handled as text. To maintain digital ink file integrity and avoid these pitfalls, the file may be attached to e-mail as an attachment. Unfortunately, even when included as an attachment, some mail server protocols will still block the attachment.

Accordingly, there is a need for ways to include digital ink files in e-mail messages without having the files blocked or corrupted in the e-mail transmission and to increase digital ink file independence from e-mail transport protocol. It would be desirable, therefore, to provide digital ink files in e-mail transport protocol independent format and to maintain the integrity of digital ink files in electronic transmission. Advantageously, sending digital ink images in e-mail would be desirable (e.g., sending digital ink data structures for retrieval by the e-mail recipient without placing special transmission requirements on the sender, receiver or transmission medium) and may also facilitate ease of transport with improved integrity and independence.

### BRIEF DESCRIPTION OF THE DRAWINGS

The foregoing and other objects, aspects and advantages will be better understood from the following detailed preferred embodiment description with reference to the drawings, in which:

FIG. 1 is an example of a digital ink data structure;

FIG. 2 shows a flow diagram of the preferred embodiment method of encoding digital ink files;

FIG. 3 is a flow diagram showing how a message with embedded digital ink encoded according to the preferred embodiment is decoded to recover the original digital ink structure and image;

FIG. 4 is a flow diagram of the preferred embodiment encoding step wherein digital images are encoded using a 64-character ASCII key;

FIGS. 5A-C are a C++ listing corresponding to the flow diagram of FIG. 4;

FIG. 6 is a flow diagram for decoding the encoded digital ink;

FIGS. 7A-B are a C++ listing corresponding to the flow diagram of FIG. 6.

### DETAILED DESCRIPTION OF THE PREFERRED EMBODIMENT OF THE INVENTION

The described embodiments provide a method and computer program product for transporting digital images across electronic media. A digital image, e.g., a signature, a handwritten note, a paint program file or anime, captured in a digital ink file is converted or compressed into a data structure including a string of binary bits. The bit string is mapped into displayable characters such as ASCII characters. The displayable characters are embedded into a message, such as being included in the text of an e-mail message and the message is transmitted electronically. When the message is received, the embedded displayable characters are stripped from it. The displayable characters are mapped to their binary equivalents and the mapped binary data stream is reconverted or decompressed to recover the digital ink file. The original digital ink image is displayed from the digital ink file. Advantageously, the digital ink image is sent in e-mail messages, received and displayed by the receiver independent of e-mail system transport protocol employed.

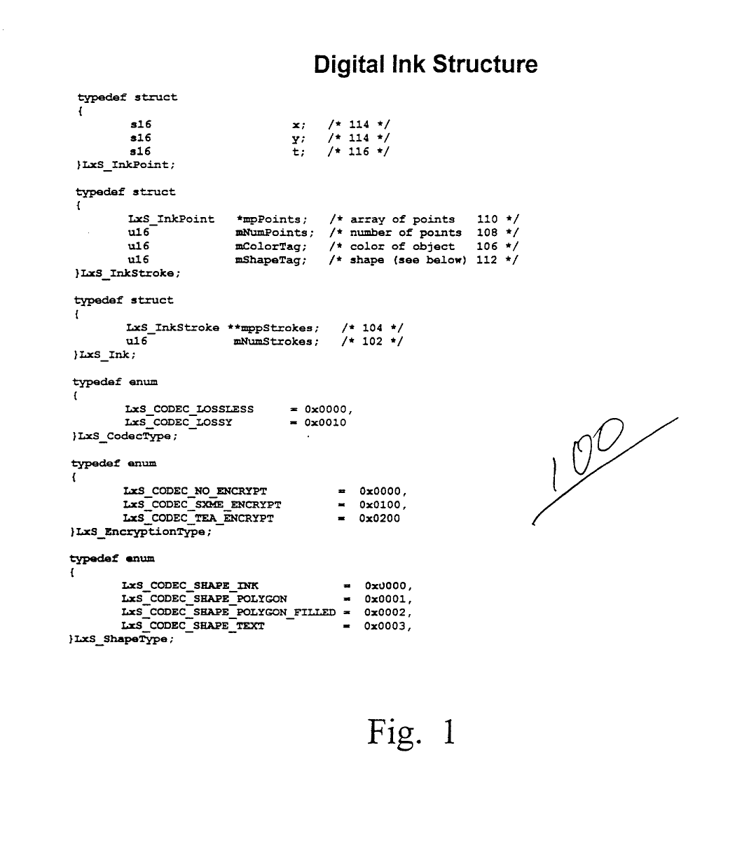

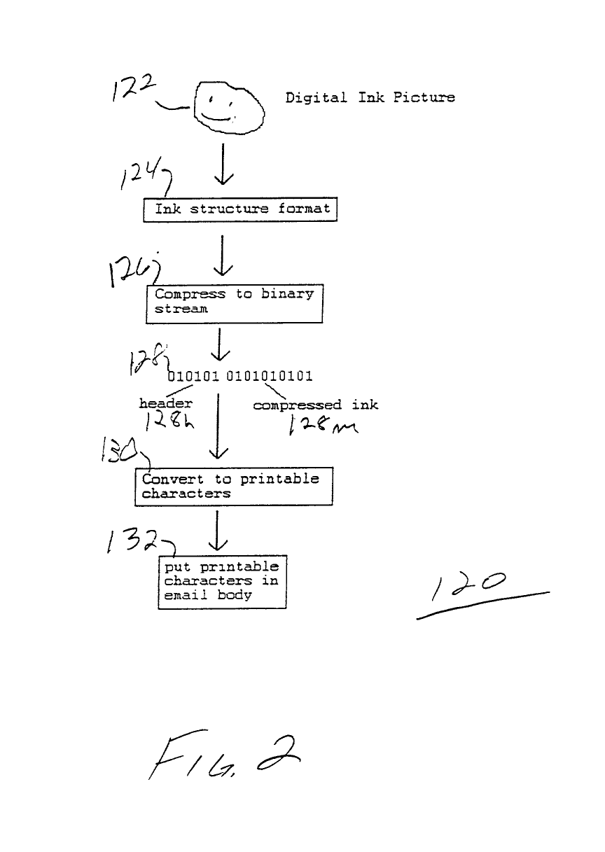

Referring now to the drawings and, more particularly, FIG. 1 is an example of digital ink structure 100. As noted hereinabove, digital ink is referred to herein as a structured description of a non-textual image such as a signature, a handwritten note or a graphical image such as a paint program image. Thus, although a typical digital ink image is manually generated, this is not a requirement. The digital ink structure, essentially, describes a manual input to produce the image and is, therefore, at its highest level a number 102 of inkstrokes 104. Each inkstroke 104 is described by ink color 106, a number of points 108 and location 110 of each of the points 108. Further, the stroke may be defined by the shape 112 of the object making the stroke. Each point 114 is described by its location 114 (x and y) and by a relative time 116 at which that point is reached.

FIG. 2 is a flow diagram of the preferred embodiment method 120 of encoding digital ink for electronic transmission according to the present invention. First, an image 122, e.g., a signature, a paint picture or digital animation (anime), is formatted in step 124 into a digital ink structure format. Then, in step 126, the digital ink picture is compressed to a binary stream using a compression codec, such as described, for example, in U.S. patent application Ser. No. 09/______ (Attorney Docket No. LX00088) entitled “COMPRESSION OF DIGITAL INK” to Manjirnath Chatterjee, filed coincident herewith and assigned to the assignee of the present invention and incorporated herein by reference. An example of a compressed digital ink stream is shown in 128 including a header 128h and a compressed digital ink message 128m. It should be noted that although the present invention is described in terms of using the codec of LXC00088, the particular codec employed is dependent upon the particular digital in message structure. Then, in step 130, the message is encoded into printable characters, such as ASCII characters. In step 132, the printable characters are embedded in the body of a message for e-mail transmission.

Preferably, the encoding process 120 is coded both using C++ and as a Java applet. Thus coded, the preferred embodiment encoding process may be included in small embedded devices that support e-mail such as a state of the art wireless organizer or, used in larger desktop computers as a web applet. A paint picture, anime or a signature contained in digital ink, can thus be securely and accurately compressed, encoded according to the preferred embodiment of the present invention; transmitted over the Internet between web connected devices, e.g., as electronic mail; and at the receiving end, decoded, decompressed and the true image displayed regardless of the e-mail protocol employed or anything else that might otherwise corrupt a digital ink image.

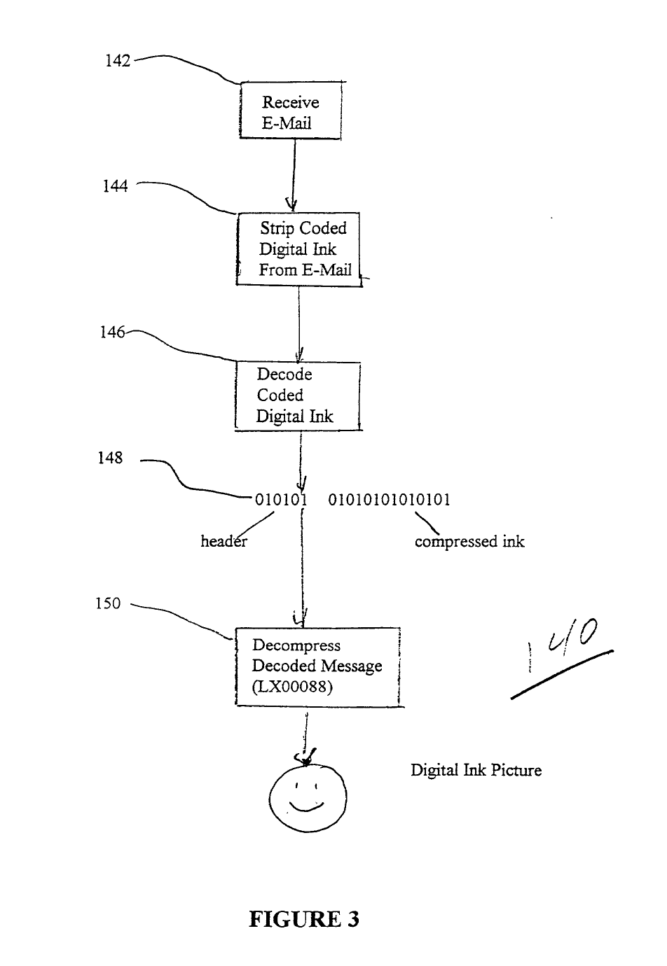

FIG. 3 is a flow diagram 140 showing how a message with embedded digital ink encoded according to the preferred embodiment 120 is decoded to recover the original digital ink structure and image. First, in step 142, a message including an encoded string of printable characters in the body is received, the string of printable characters corresponding to an encoded digital ink image. Then, in step 144, the encoded digital ink is stripped out of the message. In step 146, the encoded message is decoded to provide a compressed data stream 148, identical to the original compressed data stream 128. In step 150 the compressed data stream is decompressed using the same codec to result in a digital ink structured image 152.

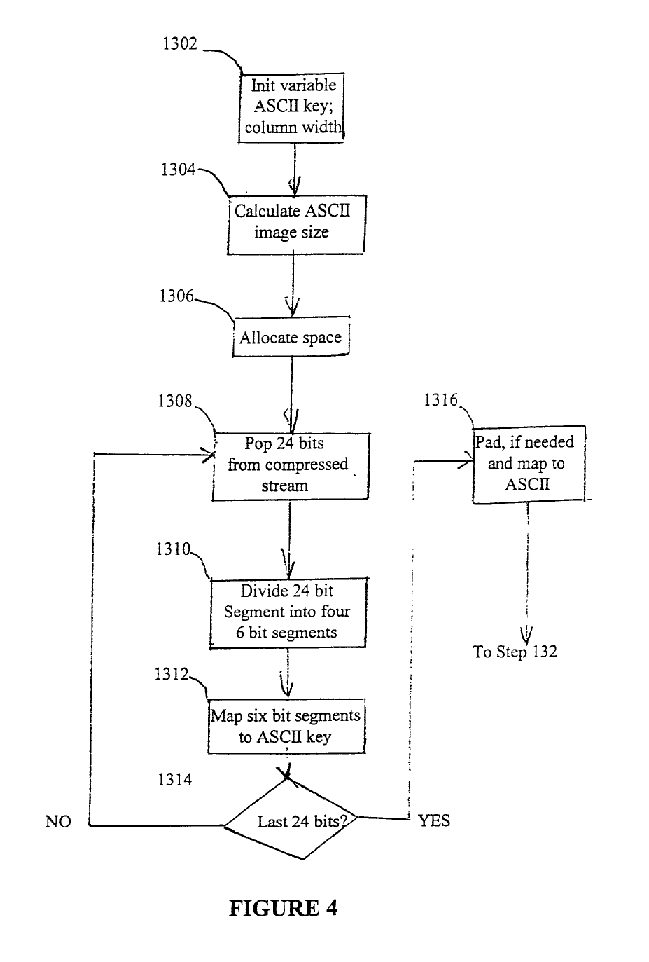

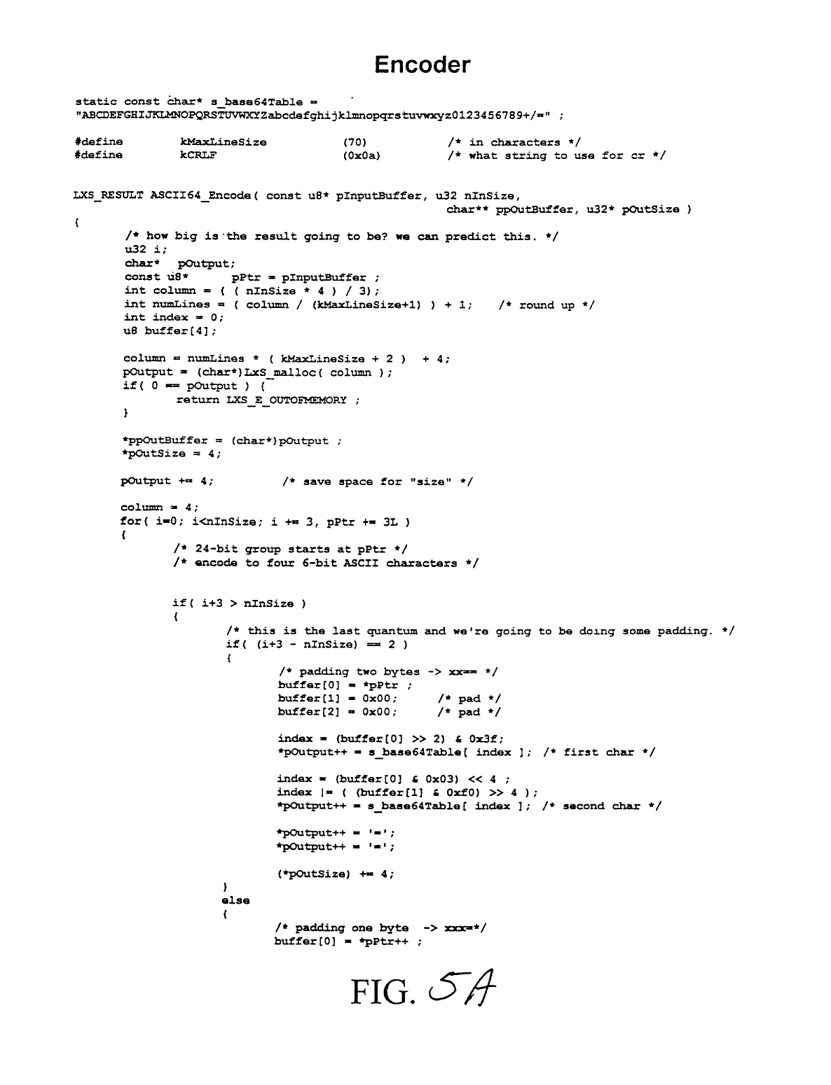

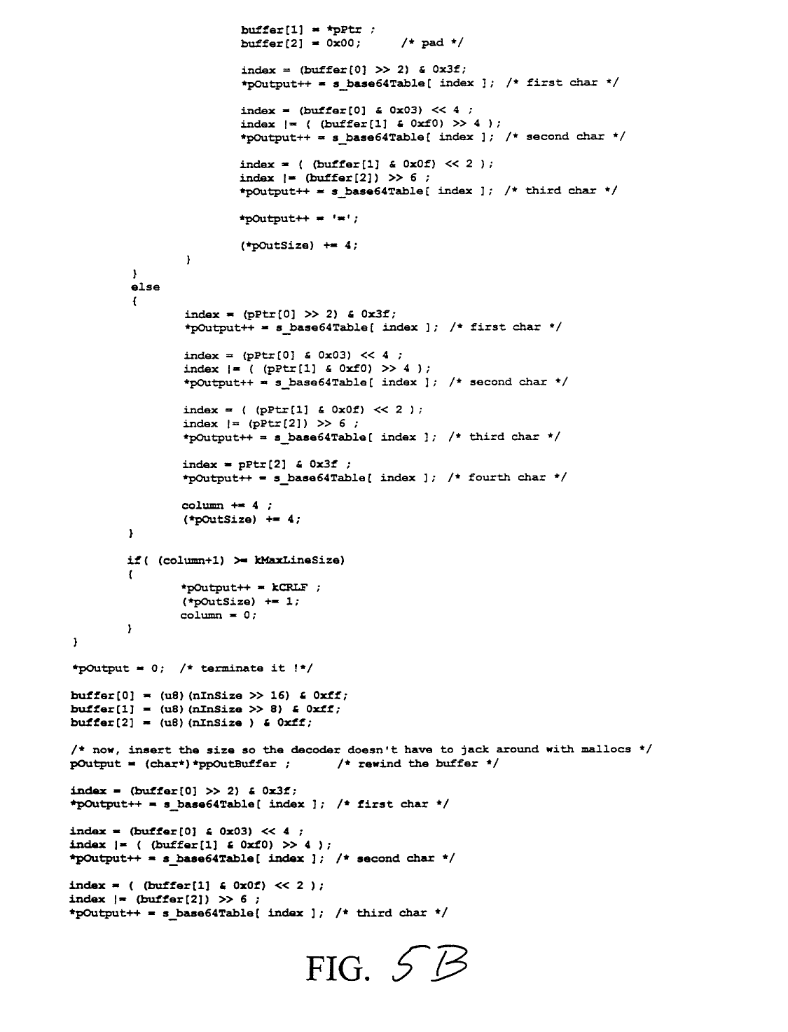

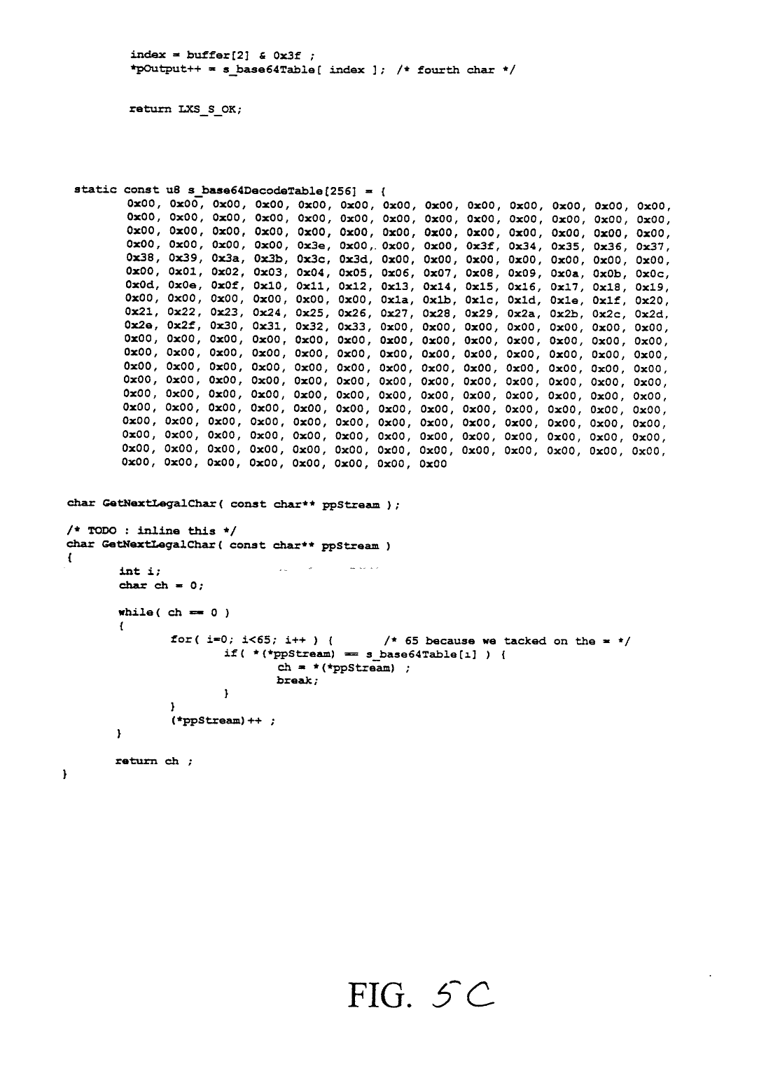

FIG. 4 is a flow diagram and FIGS. 5A-C are a corresponding C++ listing of the preferred embodiment encoding step 130 wherein digital images are encoded using a 64-character ASCII key and a 65^{th} place keeper/end of message character, as initially specified in step 1302. For example only, the key is described herein with the selected 65 ASCII characters including all capital letters A-Z, all small letters a-z, ASCII numerals 0-9, the plus (+) sign, the forward slash (/), and the equal sign (=) as the 65^{th} character. It is understood that any 65 displayable characters can be selected for encoding in any order. To be compatible with typical e-mail messages, the preferred maximum line size is defined as 70 characters and a carriage return/line feed character also is defined. While ASCII characters may be 7 or 8 bits wide, the 8-bit ASCII alphabet is preferred. Although for the preferred embodiment, 6-bit segments of the compressed data stream are each mapped to an 8-bit ASCII character, this is for example only and not intended as a limitation. Once mapped, the 8-bit ASCII character stream is included in the body of the e-mail as 70 character lines. Since, prior to the conversion, the size of the compressed digital ink image is known, the corresponding final size of the encoded ASCII data stream can be determined by dividing the number of bits in the compressed image by six and rounding up in step 1304. Due to this six bit to eight bit coding conversion, the ASCII message is approximately 33% larger than the compressed data file. Once the size of the encoded image is determined in step 1304, space is allocated for the encoded image in step 1306.

Having allocated space in step 1306, coding begins. The compressed stream is segmented into 24-bit segments in step 1308, e.g., popping 24 bits off the compressed data stream. Then, in step 1310, the 24 bit segment is divided into four 6-bit segments. Selection of 24 bits is for example only and not intended as a limitation. Any multiple of the mapped segment (6 bits) may be selected. In step 1312 each 6 bit segment is mapped to an ASCII character. Since it is unlikely that the compressed digital ink stream is an exact multiple of 24 bits, some provision must be made to extend the stream, slightly, padding it with blanks or unused bits such that the padded stream is divisible by 24. So, encoding continues until the last 24-bit segment or padded segment is found in step 1314 and encoded in step 1316. Having encoded the compressed digital stream into a viewable format, the encoded digital ink segment is inserted in an e-mail message in step 132. When the message is received, a decoder at the receiving end decodes the uncorrupted digital ink message correctly.

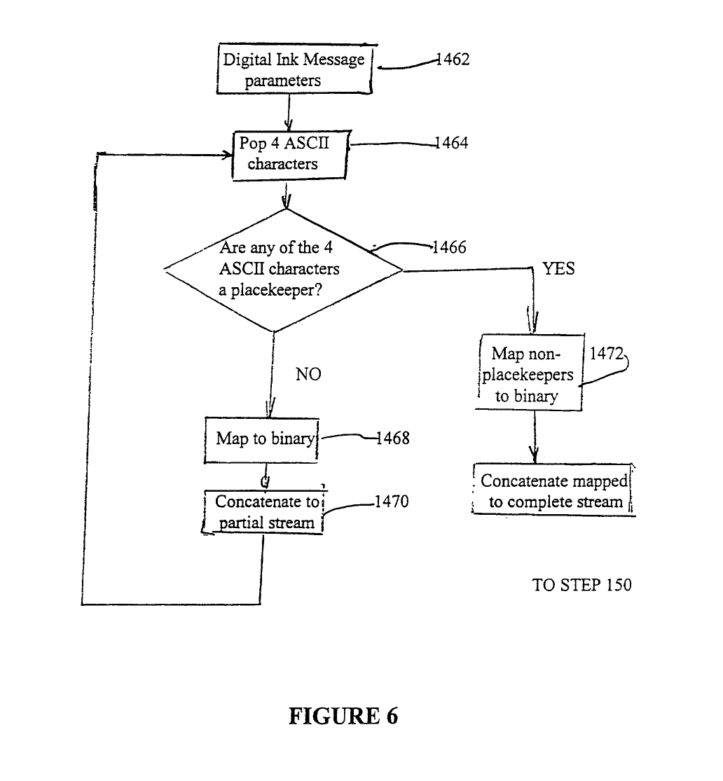

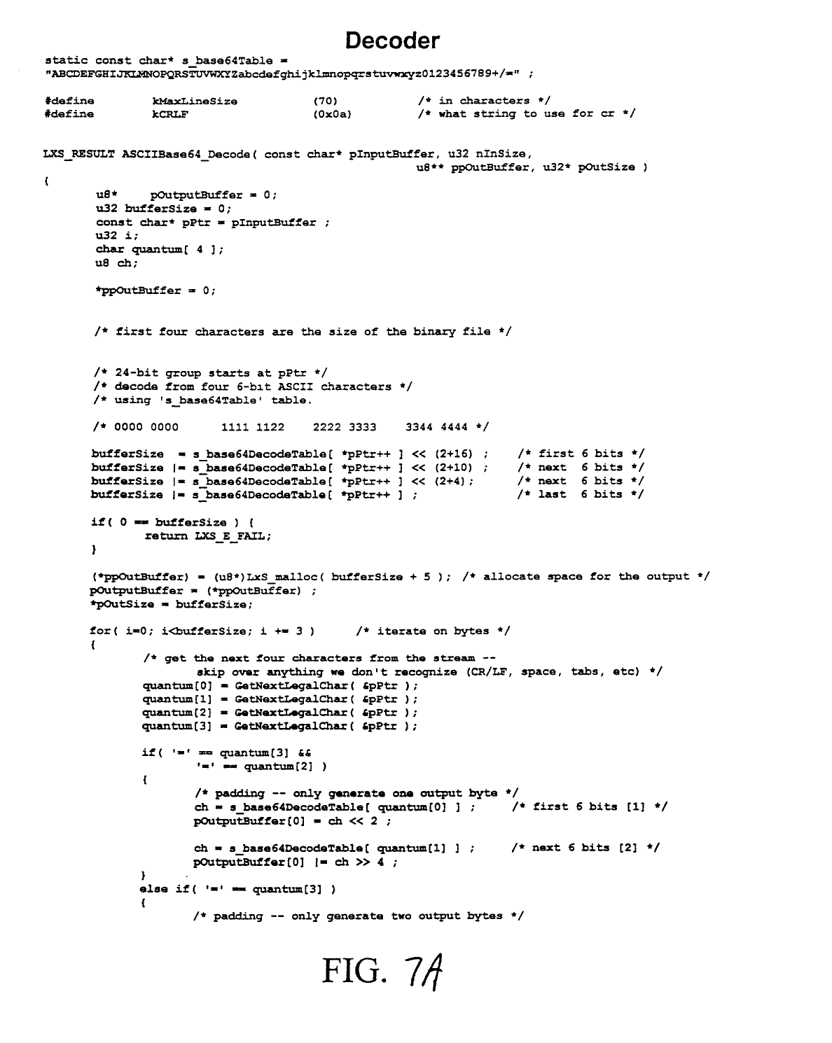

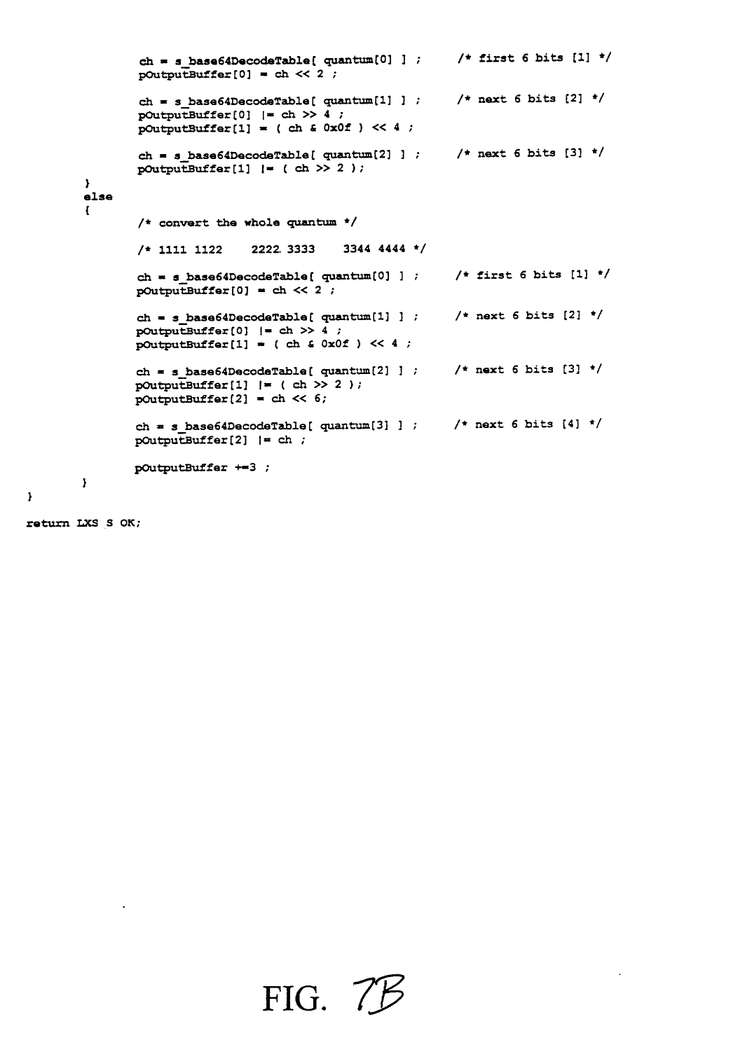

FIGS. 6 is a flow diagram and FIGS. 7A-B are a corresponding C++ listing for decoding the encoded digital ink, decoded in step 146 according to the preferred embodiment of the present invention. Decoding, essentially, is reverse of encoding, each character being mapped to its 6 bit counterpart and the mapped result concatenated to the partially decoded compressed data stream. First, in step 1462 initial variables are retrieved. The first 4 characters of the message include the unencoded size of the encoded digital ink and space is allocated for the decoded file. Then, in step 1464, groups of 4 ASCII characters at a time are retrieved from the decoded message. Again, selection of 4 ASCII characters at a time is for example only and not intended at a time. In step 1466, as each four character segment is selected, it is checked for a place keeper/end of message character, i.e., the equal sign (=) in this example. If none of the 4 ASCII characters is a place keeper/end of message character, then, in step 1468, the four 6-bit digital binary strings are extracted from the 24 ASCII characters and concatenated to reform the 24 bit segment of the compressed digital ink stream. In step 1470, the 24 bit segment is concatenated to the partially decoded compressed data stream until the entire ASCII file is decoded. If, in step 1466, a place keeper/end of message character (=) is found, in step 1474 the decoding ends. Thus, having the decoded image, the data stream is decompressed in step 150 using a corresponding decompression technique appropriate for the corresponding compression technique used in compressing the input stream, i.e., LX00088 in this example. After decompressing, the digital ink has been returned to its original form and may be displayed using a typical digital ink display technique.

Thus employing the present invention, digital ink images are sent, received and displayed by the receiver independent of e-mail system transport protocol that may be employed.

While the invention has been described in terms of preferred embodiments, those skilled in the art recognize that the invention can be practiced with modification within the spirit and the scope of the appended claims. It is intended that all such variations and modifications fall within the scope of the present invention.

We claim:

1. A method of transporting a digital image across electronic medium, said method comprising the steps of:
a) converting a digital ink image into a string of binary bits;
b) mapping said string of bits into a plurality of displayable characters;
c) embedding said displayable characters in a message; and
d) electronically transferring said message across an electrical medium.

2. A method as in claim 1, wherein the step (b) of mapping to displayable characters comprises the steps of:
i) popping a segment of a first bit size from said binary stream;
ii) segmenting said first bit size segment into a plurality of smaller segments;
iii) mapping each of said smaller segments to a corresponding displayable character, each of said corresponding displayable characters being combined to form a displayable segment; and
iv) concatenating said displayable segment to a partially coded message.

3. A method as in claim 2, wherein said displayable characters are ASCII characters.

4. A method as in claim 3, wherein the first segment is 24 bits long and each of the smaller segments are six bits long.

5. A method as in claim 4, wherein each six bit segment is mapped to an 8-bit ASCII character.

6. A method as in claim 5, wherein the converted ASCII message is included in an e-mail message and transmitted as e-mail.

7. A method as in claim 6, wherein the step (a) of converting the digital ink message into a binary string comprises compressing a digital ink formatted image to a binary bit string.

8. A method as in claim 7, wherein the compressed binary string includes a header and a compressed digital ink bit string.

9. A method of transporting a digital ink image as in claim 1, further comprising the steps of:
e) receiving said message;
f) stripping said embedded displayable characters from said received message;
g) decoding said embedded displayable characters to reform said converted digital ink image;
h) reconverting said converted digital ink image; and
j) displaying said digital ink image.

10. A method as in claim 9, wherein said the step (g) of decoding the embedded displayable characters comprises the steps of:
i) mapping said displayable characters to corresponding binary strings; and
ii) concatenating said corresponding binary strings to a partially decoded segment.

11. A method as in claim 10, wherein after all of the displayable characters are mapped to binary segments in the mapping step (i), the decoding step (g) further comprising the step of:
iii) decompressing the concatenated string of binary bits to recover a digital ink file.

12. A method as in claim 11, wherein the electronic transmission is an e-mail transmission.

13. A computer program product for transporting a digital image across electronic media, said computer program product comprising a computer usable medium having computer readable program code thereon, said computer readable program code comprising:
computer readable program code means for converting a digital ink image into a string of binary bits;
computer readable program code means for mapping said string of bits into a plurality of displayable characters;
computer readable program code means for including said displayable characters in a message; and
computer readable program code means for transferring said message across an electrical medium.

14. A computer readable program code means for transporting a digital image across electronic media as in claim 13, wherein the computer readable program code means for converting to printable characters comprises:
computer readable program code means for popping a segment of a first bit size from said binary stream;
computer readable program code means for segmenting said first bit size segment into a plurality of smaller segments;
computer readable program code means for mapping each of said smaller segments to a corresponding displayable character, each of said corresponding displayable characters being combined to form a displayable segment; and
computer readable program code means for concatenating said displayable segment to a partially coded message.

15. A computer readable program code means for transporting a digital image across electronic media as in claim 14, wherein said displayable characters are ASCII characters and the computer readable program code means for converting a digital ink image compresses the digital ink image.

16. A computer readable program code means for transporting a digital image across electronic medium as in claim 15, wherein the first segment is 24 bits long and each of the smaller segments arc six bits long, each six bit segment being mapped to an 8-bit ASCII character.

17. A computer readable program code means for transporting a digital image across electronic medium as in claim 16, wherein the converted ASCII message is included in an e-mail message and transmitted as e-mail.

18. A computer program product for receiving an electronically transmitted digital image, said computer program product comprising a computer usable medium having computer readable program code thereon, said computer readable program code comprising:
computer readable program code means for receiving an electronically transmitted message;
computer readable program code means for stripping embedded displayable characters from said received message;
computer readable program code means for decoding said stripped displayable characters to form a binary data string representative of a digital ink image;
computer readable program code means for extracting said digital ink image; and
computer readable program code means for displaying said digital ink image.

19. A computer readable program code means for receiving an electronically transmitted digital image as in claim 18, wherein the computer readable program code means for decoding the displayable characters comprises:
computer readable program code means for mapping said displayable characters to corresponding binary strings; and
computer readable program code means for concatenating said corresponding binary strings to a partially decoded binary segment.

20. A computer readable program code means for receiving an electronically transmitted digital image as in claim 19, wherein the digital image is included in an e-mail message and the computer readable program code means for extracting the digital image decompresses the concatenated string of binary bits to recover a digital ink file, said digital ink image being described in said digital ink file.
